(19) United States
(12) Patent Application Publication
(10) Pub. No.: US 2026/0341102 A1
(43) Pub. Date: Oct. 29, 2026

(54) GAME-TABLE COMPUTER DEVICE AND SYSTEM

(71) Applicant: SEGA SAMMY HOLDINGS INC., Shinagawa-ku, Tokyo (JP)

(72) Inventors: Yuji SHIMADA, Tokyo (JP); Makoto KANEKO, Tokyo (JP); Junichi NOZAWA, Tokyo (JP); Naoki TAKADA, Tokyo (JP); Ryuta MATSUDA, Tokyo (JP); Osamu KATAYAMA, Tokyo (JP)

(21) Appl. No.: 19/117,084

(22) PCT Filed: Jan. 30, 2023
(86) PCT No.: PCT/JP2023/002895

§ 371 Date: Mar. 31, 2025

(51) Int. Cl. G07F 17/32; G08B 7/06

(52) U.S. Cl. CPC G07F 17/322; G07F 17/3293; G08B 7/06

(57) ABSTRACT

Provided is a game-table control technology that enables a card game to proceed speedily, for example. A game table includes a reading device that reads card information, a computer device that manages the proceeding of the game, and a notification device. The computer device includes a storage unit that stores rule information for the card game, and a detection control unit that detects an error about dealing of cards based on the result of comparison between the card information and the rule information and records or outputs the detected error.

### CROSS-REFERENCE TO RELATED APPLICATIONS

This application is a national stage application of International Application No. PCT/JP2023/002895, filed on Jan. 30, 2023.

### FIELD

The present invention relates to a game-table computer device and a system.

### BACKGROUND

Card games such as baccarat and blackjack are widely played in amusement facilities such as casinos. In card games, a game proceeds as a dealer deals cards sequentially on a play area on a game table, and the win-loss result is determined (see, for example, Patent Literature 1).

### CITATION LIST

### Patent Literature

Patent Literature 1: Japanese Patent Application Publication No. 2003-070956

### SUMMARY

The order in which cards are dealt by the dealer, the numbers and positions of the cards, and other details are provided for by the game rules, laws, regulations, and other rules (hereinafter simply referred to as “rules”). The following issue has been pointed out as a problem. As the win-loss result of a game depends on cards that are dealt, an error about dealing of cards (for example, a violation of a rule as to the order in which cards are dealt, or the numbers or positions of cards) may cause significant damage to users, a casino operator, and other related parties if the dealer proceeds with the game unaware of the error. This brings about the need to proceed with the game carefully, and ends up hindering the game from proceeding speedily.

The present invention has been made in view of the circumstances described above, and is directed to providing a game-table control technology that enables a card game to proceed speedily, for example.

A game-table computer device according to one aspect of the present invention manages the proceeding of a card game that uses a game table provided with a reading device configured to read card information on cards dealt into a play area. The computer device includes a storage unit configured to store rule information on the card game, and a detection control unit configured to detect an error about dealing of the cards based on a result of comparison between the card information and the rule information and record or output the detected error.

### Advantageous Effects of Invention

According to the present invention, a card game is enabled to proceed speedily, for example.

### BRIEF DESCRIPTION OF DRAWINGS

FIG. 1 is a block diagram illustrating an example of a game table according to the present embodiment.

FIG. 2 is a plan view illustrating an example of the exterior top surface of the game table.

FIG. 3 is an enlarged illustration of a play area of the game table.

FIG. 4 is a block diagram illustrating a functional configuration of a computer device.

FIG. 5A is a diagram exemplarily illustrating a flowchart according to a first operation example.

FIG. 5B is a diagram exemplarily illustrating a flowchart according to the first operation example.

FIG. 6A is a diagram exemplarily illustrating a flowchart according to a second operation example.

FIG. 6B is a diagram exemplarily illustrating a flowchart according to the second operation example.

FIG. 7 is a block diagram illustrating another aspect of the functional configuration of the computer device.

### DESCRIPTION OF EMBODIMENTS

Preferred embodiments of the present invention are described herein with reference to the accompanying drawings. In each of the drawings, elements with the same symbol have the same or similar configuration.

### Explanation of Terms

In this specification, terms are defined as follows.

“Game table” refers to a table on which various games are played in an amusement facility. Generally, one dealer is appointed at each table. In addition, two or more users can participate in a game at the same time at each table.

“Dealer” refers to a person on the part of the amusement facility who controls the proceeding of a card game by, for example, dealing cards that are used in the game.

“User” refers to a person who visits the amusement facility and participates in a card game.

“Baccarat” refers to a traditional card game in which the user bets on the win or loss between the banker and the player in a card game. It is popular in casinos around the world due to its ease of use in that a user only needs to simply predict the winner of a game. The dealer deals two or three trump cards to each of the banker and player according to a certain rule, and the winner is one to whom cards having numbers that total to a value with the last digit closer to 9 have been dealt.

“Tip” refers to a virtual coin that the user uses to express his or her prediction. One tip has a certain amount of credits or points.

“Betting” refers to the user's act of declaring a prediction and placing a bet, specifically, placing a tip or tips on a betting area. For example, in baccarat, this means predicting whether the banker will win, the player will win, or the game will end in a tie, and betting on this prediction.

“Play area” refers to an area on the game table where each card is placed. In other words, this is the area where the dealer deals each card as the game proceeds. For example, in baccarat, the area where cards to the banker side are placed and the area where cards to the player side are placed are clearly marked on the game table.

“Betting area” refers to an area on the game table where tips are bet. In other words, it is an area where the user bet a tip. For example, in baccarat, areas where bets are placed in accordance with the prediction that the banker will win, the player will wins, or the game will end in a tie are clearly marked on the game table.

### A. The Present Embodiment

The following describes the configuration of a game table according to the present embodiment by taking as an example a game table for playing baccarat, a traditional card game.

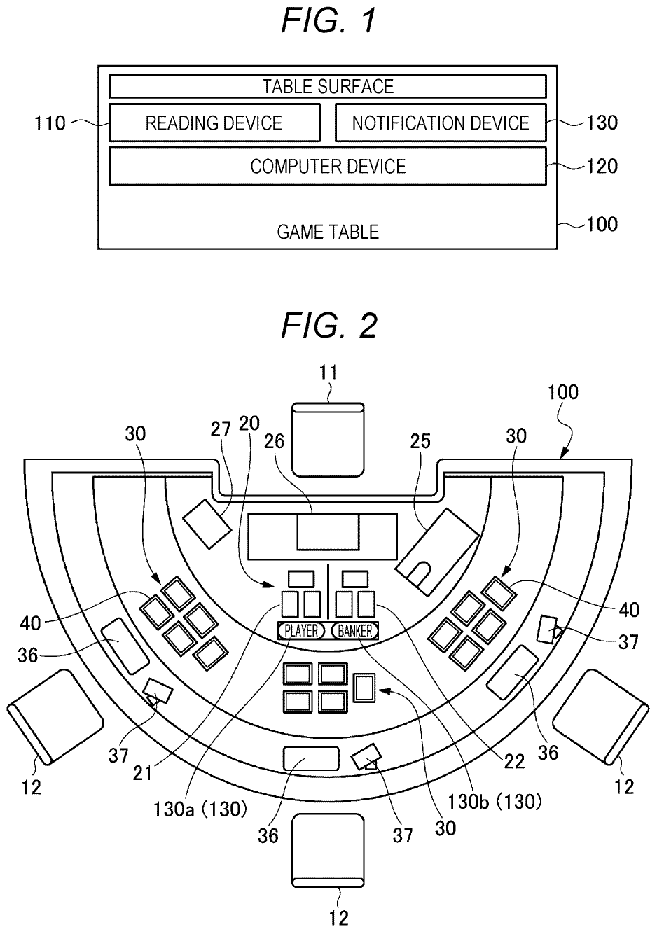

FIG. 1 is a block diagram illustrating an example of a game table 100 according to the present embodiment.

As illustrated in FIG. 1, the game table 100 includes: a reading device 110 that reads cards dealt by the dealer, a computer device 120 that manages the proceeding of a game, and a notification device 130 for navigating the dealer through the proceeding of the game and providing notification of errors about dealing of cards.

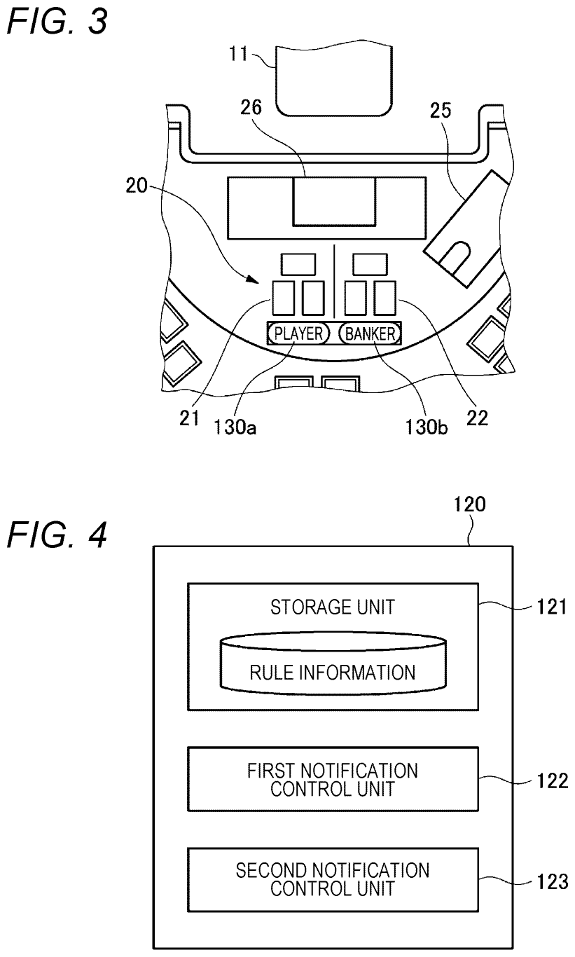

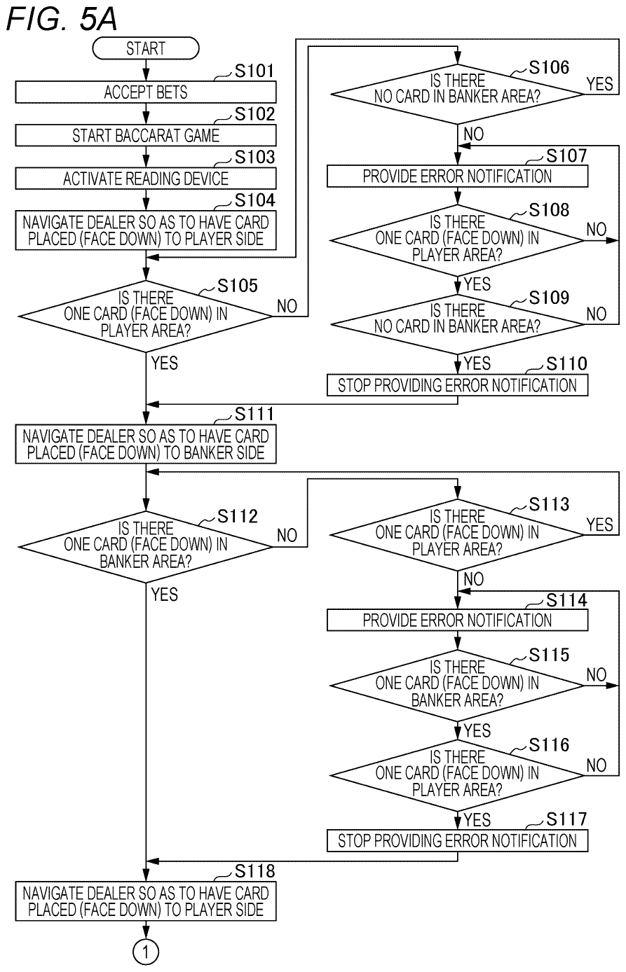

FIG. 2 is a plan view illustrating an example of the exterior top surface of the game table 100 according to the present embodiment. FIG. 3 is an enlarged illustration of a play area of the game table 100.

This game table 100 is, for example, a semicircular table provided with a play area 20 and two or more betting areas 30 where the users bet (place) tips.

As illustrated in FIGS. 2 and 3, the play area 20 is arranged, on the game table 100, in front of a dealer seating part 11. A card shoe 25 for accommodating cards to be dealt by the dealer, a dividend tip container 26 for accommodating tips for dividends, and a display unit 27 configured of a display or the like for the dealer to check the proceeding and result of the game are provided in the vicinity of the play area 20.

In the play area 20, a player area 21 where cards to the player side are placed, and a banker area 22 where cards to the banker side are placed are arranged. A player-side notification lamp 130a is provided in the vicinity of the player area 21, and a banker-side notification lamp 130b is provided in the vicinity of the banker area 22. The player-side notification lamp (light emission unit) 130a and the banker-side notification lamp (light emission unit) 130b include, for example, LEDs and constitute the notification device 130. In the present embodiment, the notification device 130 is provided, near the boundary between the play area 20 and the betting areas 30, substantially in front of the dealer. This allows the dealer to check information provided by the notification device 130 during the course of a game without having to considerably change the line of sight of the dealer. However, the shape and position of the notification device 130 are not limited by the present embodiment, and can be changed as needed in consideration of the visibility from the dealer and the user. In the play area 20, what are arranged are not limited to the player area 21 and banker area 22, and it is only necessary to arrange one or more card placement area corresponding to a game selected from various games. In addition, it is only necessary to provide the notification device 130 in a manner corresponding to each of the areas.

As an example, the player-side notification lamp 130a illuminates in white when the dealer should place a card to the player side, whereas the banker-side notification lamp 130b illuminates in white when the dealer should place a card to the banker side. Each of the notification lamps 130a and 130b flashes in red when a mistake (i.e., an error about dealing of cards) is made by the dealer in dealing of cards. Thus, controlling the illumination of the player-side notification lamp 130a and the banker-side notification lamp 130b results in navigating the dealer and the users participating in the game as to when to deal the next card and notifying the dealer and the users of an error about dealing of cards.

Referring back to FIG. 2, three user seating parts 12 are provided facing the dealer seating part 11. On one game table 100, three betting areas 30 are arranged corresponding to the number of user seating parts 12. While three betting areas 30 are provided on one game table 100 in the present embodiment, this configuration is not limiting. In each of the betting areas 30, a banker pair area, a player pair area, a banker area, a player area, and a tie area are arranged. The banker pair area is an area for betting on a pair on the banker side. The player pair area is an area for betting on a pair on the player side. The banker area is an area for betting on the win of the banker. The player area is an area for betting on the win of the player. The tie area is an area for betting on the tie. The variation of betting areas is not limited to this one.

Referring back to FIG. 1, the reading device 110 is a device that reads card information on cards dealt by the dealer, which is provided, for example, on the underside of the table surface corresponding to the play area 20. The reading device 110 is configured of an infrared bar code reader or similar device. On each card, a bar code that indicates the type (the suit and number of the card, such as “heart and ace”) and the face or back of the card is printed in special ink or other means. The reading device 110 reads the bar codes on each card dealt by the dealer on the play area 20, thus being capable of reading card information, including the type of the card, the face or back of the card, and the position of the card. The card information read by the reading device 110 is transmitted to the computer device 120.

The configuration that enables reading the card information is not limited to one that uses a bar code reader, but may be one that uses an IC tag, a camera, or the like. For example, the reading device 110 may extract the card information by reading an IC tag embedded in the card, or the reading device 110 may take an image of the card and perform pattern matching or similar processing.

Referring back to FIG. 2, a display unit 36 that each of the users uses to display the proceeding and result of a game, and a card reading unit 37 for reading a user card of each of the users are provided on a part between the corresponding betting area 30 and the user seating part 12 on the game table 10. The user card is a medium in which identification data (ID) of the user and game information are stored. For example, it can store points earned as a result of games previously played.

Referring back to FIG. 1, the computer device 120 is, for example, a server computer or the like and may include a control unit (including a central processing unit (CPU) and a memory), a hard disk drive (HDD), and a network interface, which are not illustrated. The computer device 120 implements the function or the like of each unit by causing the control unit to temporarily load onto the memory a program stored in the HDD and causing the CPU to execute the program loaded onto the memory. Here, at least some of the units of the computer device 120 may be implemented by a plurality of computer devices interconnected through various networks. Additionally, at least some of the units of the computer device 120 may be implemented by distributed processing by a plurality of computer devices.

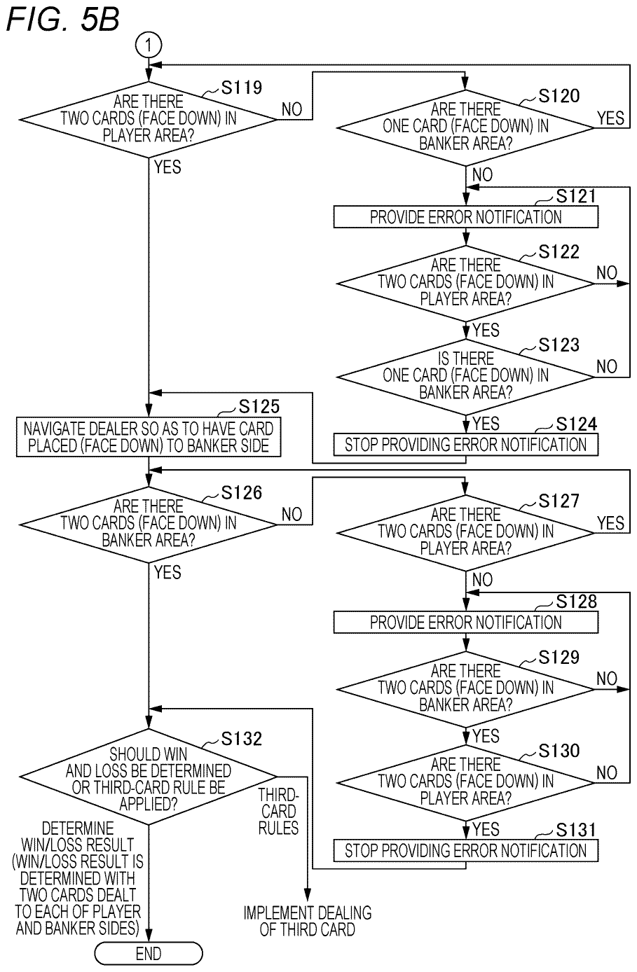

FIG. 4 is a block diagram illustrating the functional configuration of the computer device 120.

As illustrated in FIG. 4, the computer device 120 includes a storage unit 121, a first notification control unit 122, and a second notification control unit 123.

The storage unit 121 stores rule information for a card game. Since baccarat is assumed as the card game in the present embodiment, the storage unit 121 stores various sets of rule information that are necessary to properly proceed with a baccarat game. Specifically, the storage unit 121 stores the rule information that specifies, for example, the order in which the dealer deals two cards each to the banker and player sides, conditions for dealing the third card to each or either of the banker and player sides (what are called “third-card rules”), the timing for turning face up a card placed face down, conditions for turning a card face up (e.g., the user with the highest bet in the game), and various rules stipulated to comply with the laws and regulations.

The first notification control unit 122, for example, detects an error about dealing of cards based on the result of comparison between the card information read by the reading device 110 and the rule information stored in the storage unit 121. Upon detecting an error about dealing of cards, the first notification control unit 122 transmits a control command to cause the notification device 130 to provide notification on the status of occurrence of the error. Here, an “error about dealing of cards” means a mistake about dealing of cards that results in a failure to properly proceed with the game, such as having an incorrect number of cards dealt, having a card placed in a wrong position, or having a card placed face up although needing to be placed face down. Specific detection operation for detecting an error about dealing of cards is described below.

The second notification control unit 123 generates navigation information for navigating the dealer through the proceeding of the game, for example, based on the result of comparison between the card information read by the reading device 110 and the rule information stored in the storage unit 121. Upon generating the navigation information, the second notification control unit 123 transmits a control command to cause the notification device 130 to provide notification of the navigation information. Here, “navigating the dealer through the proceeding of the game” means guiding the dealer as to, for example, where the next card should be dealt. Specific operation for navigating the dealer through the proceeding of the game is described below. The navigation information itself may be stored in advance in the storage unit 121 and generated through selection of corresponding information from the navigation information based on the result of comparison between the card information read by the reading device 110 and the rule information stored in the storage unit 121.

The computer device 120 described above is connected to the game table 100 through wireless or wired communication, and thus can exchange information with the game table 100. The computer device 120 may be mounted on the game table 100 or may be provided in the amusement facility via a relay device such as a router. Obviously, the computer device 120 may alternatively be provided outside the amusement facility.

The game table 100 has other functions, such as wirelessly feeding power to rechargeable tips placed on the table surface, determining the amounts of tips placed by the respective users, and determining the legitimacy of tips.

The following describes, through typical examples, operation for navigating the dealer through the proceeding of the game and operation for providing notification of an error about dealing of cards. It is assumed that the computer device 120 refers as appropriate to the card information on cards, which is supplied by the reading device 110, and the rule information stored in the storage unit 121.

### First Operation Example (Operation when Cards are Dealt in a Normal Manner)

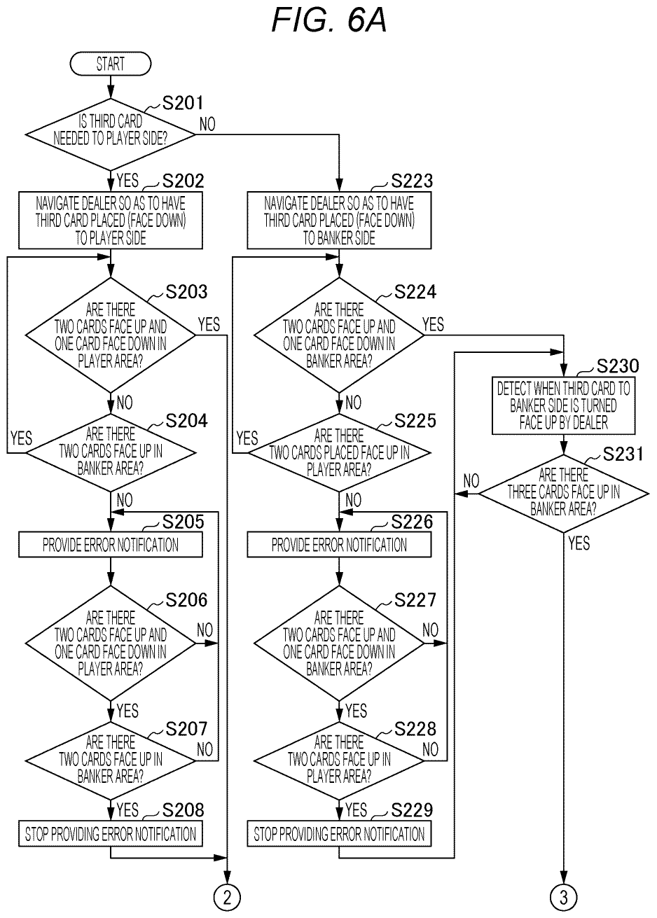

FIGS. 5A and 5B are diagrams exemplarily illustrating flowcharts according to a first operation example.

In step S101, when a game is started, the computer device 120 first starts accepting bets in the betting area 30 on the game table 100. Each of the users selects one or more of the banker pair area, the player pair area, the banker area, the player area, and the tie area and bets tips on the selected area or areas (see FIG. 2).

In steps S102 and S103, the computer device 120 activates the reading device 110 upon receiving an instruction to start a baccarat game through operation on a button by the dealer. Following an instruction from the computer device 120, the reading device 110 starts reading card information on cards dealt into the play area 20.

In step S104, the computer device 120 causes the player-side notification lamp 130a to illuminate in white, thereby navigating the dealer so as to have one card (face down) placed to the player side. By seeing the player-side notification lamp 130a illuminating in white, the dealer recognizes that one card (face down) needs to be placed in the player area 21.

In step S105, the computer device 120 determines whether there is one card (face down) placed in the player area 21 by the dealer. Upon determining that there is not one card (face down) placed in the player area 21 (NO in step S105), the computer device 120 proceeds to step S106 and, upon determining that there is one card (face down) placed in the player area 21 (YES in step S105), proceeds to step S111.

In step S106, the computer device 120 determines whether there is no card placed in the banker area 22. If there is no card placed in the banker area 22 at this point (YES in step S106), the computer device 120 returns to step S105. Otherwise, or if there is any card placed in the banker area 22 at this point (NO in step S106), the computer device 120 determines that the status of card dealing is not normal and proceeds to step S107.

In step S107, the computer device 120 causes the player-side notification lamp 130a and the banker-side notification lamp 130b to flash in red, and proceeds to step S108. By seeing the player-side notification lamp 130a and the banker-side notification lamp 130b flashing in red, the dealer recognizes that an error about dealing of cards has occurred.

In step S108, the computer device 120 determines whether there is one card (face down) placed in the player area 21 by the dealer. Upon determining that there is not one card (face down) placed in the player area 21 (NO in step S108), the computer device 120 returns to step S107 to continue providing notification of an error about dealing of cards. Otherwise, or upon determining that there is one card (face down) placed in the player area 21 (YES in step S108), the computer device 120 proceeds to step S109.

In step S109, the computer device 120 determines whether there is no card placed in the banker area 22. If there is any card placed in the banker area 22 at this point (NO in step S109), the computer device 120 determines that the status of card dealing is still not normal and returns to step S107 to continue providing notification of an error about dealing of cards. Otherwise, or if there is no card placed in the banker area 22 at this point (YES in step S109), the computer device 120 determines that the status of card dealing has returned to normal, and proceeds to step S110.

In step S110, the computer device 120 turns off the player-side notification lamp 130a and the banker-side notification lamp 130b, and proceeds to step S111. By seeing the player-side notification lamp 130a and the banker-side notification lamp 130b turned off, the dealer recognizes that the error about dealing of cards has been resolved.

In step S111, the computer device 120 causes the banker-side notification lamp 130b to illuminate in white, thereby navigating the dealer so as to have one card (face down) placed in the banker area 22. By seeing the banker-side notification lamp 130b illuminating in white, the dealer recognizes that one card (face down) needs to be placed in the banker area 22.

In step S112, the computer device 120 determines whether there is one card (face down) placed in the banker area 22 by the dealer. Upon determining that there is not one card (face down) placed in the banker area 22 (NO in step S112), the computer device 120 proceeds to step S113 and, upon determining that there is one card (face down) placed in the banker area 22 (YES in step S112), proceeds to step S118.

In step S113, the computer device 120 determines whether there is one card (face down) placed in the player area 21. If there is one card (face down) placed in the player area 21 at this point (YES in step S113), the computer device 120 returns to step S112. Otherwise, or if there is not one card (face down) placed in the player area 21 at this point (NO in step S113) because there is no card (face down) placed or are two or more cards (face down) placed in the player area 21, the computer device 120 determines that the status of card dealing is not normal and proceeds to step S114.

In step S114, the computer device 120 causes the player-side notification lamp 130a and the banker-side notification lamp 130b to flash in red, and proceeds to step S115. By seeing the player-side notification lamp 130a and the banker-side notification lamp 130b flashing in red, the dealer recognizes that an error about dealing of cards has occurred.

In step S115, the computer device 120 again determines whether there is one card (face down) placed in the banker area 22. Upon determining that there is not one card (face down) placed in the banker area 22 (NO in step S115), the computer device 120 returns to step S114 to continue providing notification of an error about dealing of cards. Otherwise, or upon determining that there is one card (face down) placed in the banker area 22 (YES in step S115), the computer device 120 proceeds to step S116.

In step S116, the computer device 120 determines whether there is one card (face down) placed in the player area 21. If there is no card placed in the player area 21 at this point (NO in step S116), the computer device 120 determines that the status of card dealing is still not normal and returns to step S114 to continue providing notification of an error about dealing of cards. Otherwise, or if there is one card (face down) placed in the player area 21 at this point (YES in step S116), the computer device 120 determines that the status of card dealing has returned to normal, and proceeds to step S117.

In step S117, the computer device 120 turns off the player-side notification lamp 130a and the banker-side notification lamp 130b, and proceeds to step S118. By seeing the player-side notification lamp 130a and the banker-side notification lamp 130b turned off, the dealer recognizes that the error about dealing of cards has been resolved.

In step S118, the computer device 120 causes the player-side notification lamp 130a to illuminate in white, thereby navigating the dealer so as to have one card (face down) placed in the player area 21. Here, the dealer recognizes that the second card (face down) should be placed in the player area 21 because there is one card (face down) already placed in the player area 21.

In step S119, with reference to the card information on a card, which is supplied by the reading device 110, and the rule information, the computer device 120 determines whether there are two cards (face down) placed in the player area 21 by the dealer. Upon determining that there are not two cards (face down) placed in the player area 21, the computer device 120 proceeds to step S120, whereas, upon determining that there are two cards (face down) placed in the player area 21, the computer device 120 proceeds to step S125.

In step S120, with reference to the card information on a card, which is supplied by the reading device 110, and the rule information, the computer device 120 determines whether there is one card (face down) placed in the banker area 22. If there is one card (face down) placed in the banker area 22 at this point (YES in step S120), the computer device 120 returns to step S118. Otherwise, or if there is not one card (face down) placed in the banker area 22 at this point (NO in step S120) because there is no card (face down) or are two or more cards (face down) placed in the banker area 22, the computer device 120 determines that the status of card dealing is not normal and proceeds to step S121.

In step S121, the computer device 120 causes the player-side notification lamp 130a and the banker-side notification lamp 130b to flash in red, and proceeds to step S122. By seeing the player-side notification lamp 130a and the banker-side notification lamp 130b flashing in red, the dealer recognizes that an error about dealing of cards has occurred.

In step S122, the computer device 120 again determines whether there are two cards (face down) placed in the player area 21. Upon determining that there are not two cards (face down) placed in the player area 21 (NO in step S122), the computer device 120 returns to step S121 to continue providing notification of an error about dealing of cards. Otherwise, or upon determining that there are two cards (face down) placed in the player area 21 (YES in step S122), the computer device 120 proceeds to step S123.

In step S123, the computer device 120 determines whether one card (face down) has been placed in the banker area 22. If there is not one card placed in the banker area 22 at this point (NO in step S123), the computer device 120 determines that the status of card dealing is still not normal and returns to step S121 to continue providing notification of an error about dealing of cards. Otherwise, or if there is one card (face down) placed in the banker area 22 at this point (YES in step S123), the computer device 120 determines that the status of card dealing has returned to normal, and proceeds to step S124.

In step S124, the computer device 120 turns off the player-side notification lamp 130a and the banker-side notification lamp 130b, and proceeds to step S125. By seeing the player-side notification lamp 130a and the banker-side notification lamp 130b turned off, the dealer recognizes that the error about dealing of cards has been resolved.

In step S125, the computer device 120 causes the banker-side notification lamp 130b to illuminate in white, thereby navigating the dealer so as to have one card (face down) placed in the banker area 22. Here, the dealer recognizes that the second card (face down) should be placed in the banker area 22 because there is one card (face down) already placed in the banker area 22.

In step S126, the computer device 120 determines whether there are two cards (face down) placed in the banker area 22 by the dealer. Upon determining that there are not two cards (face down) placed in the banker area 22 (NO in step S126), the computer device 120 proceeds to step S127, whereas, upon determining that there are two cards (face down) placed in the banker area 22 (YES in step S126), the computer system 120 proceeds to step S132.

In step S127, the computer device 120 again determines whether there are two cards (face down) placed in the player area 21. If there are two cards (face down) placed in the player area 21 at this point (YES in step S127), the computer device 120 returns to step S126. Otherwise, or if there are not two cards (face down) placed in the player area 21 at this point (NO in step S127) because there is no card (face down) or only one card (face down) placed in the player area 21, the computer device 120 determines that the status of card dealing is not normal and proceeds to step S128.

In step S128, the computer device 120 causes the player-side notification lamp 130a and the banker-side notification lamp 130b to flash in red, and proceeds to step S129. By seeing the player-side notification lamp 130a and the banker-side notification lamp 130b flashing in red, the dealer recognizes that an error about dealing of cards has occurred.

In step S129, with reference to the card information on a card, which is supplied by the reading device 110, and the rule information, the computer device 120 again determines whether there are two cards (face down) placed in the banker area 22. Upon determining that there are not two cards (face down) placed in the banker area 22 (NO in step S129), the computer device 120 returns to step S128 to continue notification of an error about dealing of cards. Otherwise, or upon determining that there are two cards (face down) placed in the banker area 22 (YES in step S129), the computer device 120 proceeds to step S130.

In step S130, the computer device 120 again determines whether there are two cards (face down) placed in the player area 21. If there are not two cards placed in the player area 21 at this point (NO in step S130), the computer device 120 determines that the status of card dealing is still not normal and returns to step S128 to continue notification of an error about dealing of cards. Otherwise, or if there are two cards (face down) placed in the player area 21 at this point (YES in step S130), the computer device 120 determines that the status of card dealing has returned to normal, and proceeds to step S131.

In step S131, the computer device 120 turns off the player-side notification lamp 130a and the banker-side notification lamp 130b, and proceeds to step S132. By seeing the player-side notification lamp 130a and the banker-side notification lamp 130b turned off, the dealer recognizes that the error about dealing of cards has been resolved.

In step S132, the computer device 120 determines whether it is possible to determine the win/loss result at this point (i.e., with two cards dealt to each of the player and banker sides) or it is needed to deal the third card to either or both of the banker and player sides based on conditions for dealing the third card (what are called “third-card rules”).

Upon determining that it is possible to determine the winner with two cards dealt to each of the player and banker sides, the computer device 120 determines, with reference to the rule information and the like, whether the banker or the player has won the game or it is in a tie, and ends the above-described operation in normal card dealing. Thereafter, a certain person such as an authorized one of the users turns the cards dealt face up to reveal the win-loss result of the game. Notification of the win-loss result may be provided through, for example, the notification device 130, the display units 27, 36, or the like. For example, when the player wins, the computer device 120 causes the player-side notification lamp 130a to illuminate in green, whereas, when the banker wins, the computer device 120 causes the banker-side notification lamp 130b to illuminate in green. In the event of a tie, for example, the computer device 120 may cause both of the player-side notification lamp 130a and the banker-side notification lamp 130b to flash in green.

Otherwise, or upon determining that the third card needs to be dealt based on the third-card rules included in the rule information, the computer device 120 implements a second operation example described below. The following description assumes that two cards dealt face down to each of the player and banker sides have already been turned face up.

### Second Operation Example (Operation when Cards are Dealt Based on the Third-Card Rules)

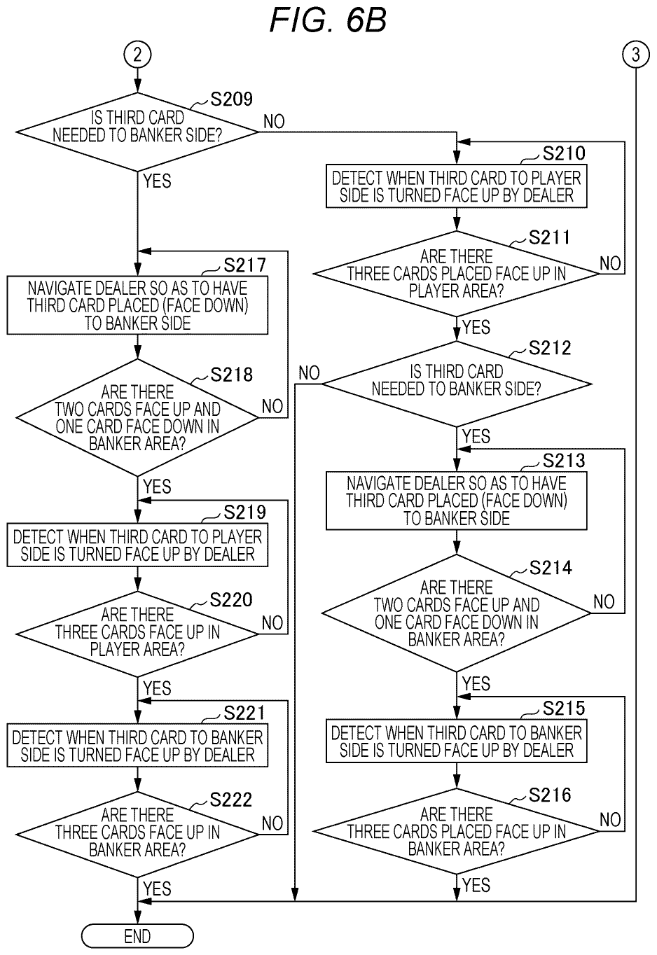

FIGS. 6A and 6B are diagrams exemplarily illustrating flowcharts according to a second operation example.

In step S201, the computer device 120 determines whether it is needed to deal the third card to the player side (i.e., whether it is needed to place the third card in the player area 21) based on the third-card rules. Upon determining that it is needed to place the third card in the player area 21 (YES in step S201), the computer device 120 proceeds to step S202, whereas, upon determining that it is needed to place the third card to the banker side, not to the player side (NO in step S201), the computer device 120 proceeds to step S223.

### If it is Needed to Deal the Third Card to the Player Side (YES in Step S201)

In step S202, the computer device 120 causes the player-side notification lamp 130a to illuminate in white, thereby navigating the dealer so as to have the third card (face down) placed in the player area 21. The dealer recognizes that the third card (face down) should be placed in the player area 21 by seeing the player-side notification lamp 130a.

In step S203, the computer device 120 determines whether there are two cards placed face up and one card placed face down in the player area 21. Upon determining that there are two cards placed face up and one card placed face down in the player area 21 (YES in step S203), the computer device 120 proceeds to step S209, whereas, upon determining that there are not two cards placed face up and one card placed face down in the player area 21 (NO in Step S203), the computer device 120 proceeds to Step S204.

In step S204, the computer device 120 determines whether there are two cards placed face up in the banker area 22. Upon determining that there are two cards placed face up in the banker area 22 (YES in step S204), the computer device 120 returns to step S203. Otherwise, or if there are not two cards placed face up in the banker area 22 (NO in step S204), the computer device 120 determines that the status of card dealing is not normal and proceeds to step S205.

In step S205, the computer device 120 causes the player-side notification lamp 130a and the banker-side notification lamp 130b to flash in red, and proceeds to step S206. By seeing the player-side notification lamp 130a and the banker-side notification lamp 130b flashing in red, the dealer recognizes that an error about dealing of cards has occurred.

In step S206, the computer device 120 again determines whether there are two cards placed face up and one card placed face down in the player area 21. For example, if the dealer, having recognized an error about dealing of cards, has newly placed one card (face down) in the player area 21, the computer device 120 determines that there are such cards in the area (“YES”), and proceeds to step S207. If there is not one card (face down) newly placed in the player area 21 (NO in step S206), the computer device 120 determines that the status of card dealing is still not normal and returns to step S205 to continue notification of an error about dealing of cards.

In step S207, the computer device 120 determines whether there are two cards placed face up in the banker area 22. If there are not two cards placed face up in the banker area 22 (NO in step S207), the computer device 120 determines that the status of card dealing is still not normal and returns to step S205 to continue providing notification of an error about dealing of cards. Otherwise, or upon determining that there are two cards placed face up in the banker area 22 (YES in step S207), the computer device 120 determines that the status of card dealing has returned to normal and proceeds to step S208.

In step S208, the computer device 120 turns off the player-side notification lamp 130a and the banker-side notification lamp 130b, and proceeds to step S209. By seeing the player-side notification lamp 130a and the banker-side notification lamp 130b turned off, the dealer recognizes that the error about dealing of cards has been resolved.

In step S209, the computer device 120 determines whether it is needed to deal the third card to the banker side (i.e., whether it is needed to newly place one card (face down) in the banker area 22) based on the third-card rules. The computer device 120 proceeds to step S217 upon determining that it is needed to deal the third card to the banker area 22 (YES in step S209), whereas the computer device 120 proceeds to step S210 upon determining that it is not needed to deal the third card to the banker area 22 (NO in step S209).

### If it is not Needed to Deal the Third Card to the Banker Side (NO in Step S209)

In step S210, upon detecting when the third card to the player side (i.e., the card newly placed face down in the player area 21) is turned face up by the dealer, the computer device 120 proceeds to step S211. In a step before step S210, the computer device 120 may, for example, cause the player-side notification lamp 130a to illuminate in blue, thereby navigating the dealer so as to have the third card (face down) to the player side turned face up.

In step S211, the computer device 120 determines whether there are three cards placed face up in the player area 21. If there are not three cards placed face up in the player area 21 (NO in step S211), the computer device 120 returns to step S210. Otherwise, or upon determining that there are three cards placed face up in the player area 21 (YES in step S211), the computer device 120 proceeds to step S212.

In step S212, the computer device 120 determines whether it is needed to deal the third card to the banker side (i.e., whether it is needed to newly place one card (face down) in the banker area 22) based on the third-card rules. The computer device 120 ends the operation in card dealing based on the third-card rules upon determining that it is not needed to deal the third card to the banker area 22 (NO in step S212), whereas the computer device 120 proceeds to step S213 upon determining that it is needed to deal the third card to the banker area 22 (YES in step S212).

### If it is Needed to Deal the Third Card to the Banker Side (YES in Step S212)

In step S213, the computer device 120 causes the banker-side notification lamp 130b to illuminate in white, thereby navigating the dealer so as to have the third card (face down) placed in the banker area 22. By seeing the banker-side notification lamp 130b, the dealer recognizes that the third card should be placed (face down) in the banker area 22.

In step S214, the computer device 120 determines whether there are two cards placed face up and one card placed face down in the banker area 22. For example, if the dealer has newly placed one card (face down) in the banker area 22, the computer device 120 determines that there are such cards in the area (“YES”), and proceeds to step S215. Upon determining that there is not one card (face down) newly placed in the banker area 22 (NO in step S214), the computer device 120 returns to step S213 to continue navigating dealing of cards.

In step S215, upon detecting when the third card to the banker side (i.e., the card newly placed face down in the banker area 22) is turned face up by the dealer, the computer device 120 proceeds to step S216. In a step before step S215, the computer device 120 may, for example, cause the banker-side notification lamp 130b to illuminate in blue, thereby navigating the dealer so as to have the third card (face down) to the banker side turned face up.

In step S216, the computer device 120 determines whether there are three cards placed face up in the banker area 22. If there are not three cards placed face up in the banker area 22 (NO in step S216), the computer device 120 returns to step S215. Otherwise, or upon determining that there are three cards placed face up in the banker area 22 (YES in step S216), the computer device 120 ends the operation in card dealing based on the third-card rules.

### If it is Needed to Deal the Third Card to the Banker Side (YES in Step S209)

In step S217, the computer device 120 causes the banker-side notification lamp 130b to illuminate in white, thereby navigating the dealer so as to have the third card (face down) placed in the banker area 22. By seeing the banker-side notification lamp 130b, the dealer recognizes that the third card should be placed (face down) in the banker area 22.

In step S218, the computer device 120 determines whether there are two cards placed face up and one card placed face down in the banker area 22. For example, if the dealer has newly placed one card (face down) in the banker area 22, the computer device 120 determines that there are such cards in the area (“YES”), and proceeds to step S219. Upon determining that there is not one card (face down) newly placed in the banker area 22 (NO in step S218), the computer device 120 returns to step S217 to continue navigating dealing of cards.

In step S219, upon detecting when the third card to the banker side (i.e., the card newly placed face down in the banker area 22) is turned face up by the dealer, the computer device 120 proceeds to step S220. In a step before step S219, the computer device 120 may, for example, cause the player-side notification lamp 130a to illuminate in blue, thereby navigating the dealer so as to have the third card (face down) to the player side turned face up.

In step S220, the computer device 120 determines whether there are three cards placed face up in the player area 21. If there are not three cards placed face up in the player area 21 (NO in step S220), the computer device 120 returns to step S219. Otherwise, or upon determining that there are three cards placed face up in the player area 21 (YES in step S220), the computer device 120 proceeds to step S221.

In step S221, upon detecting when the third card to the banker side (i.e., the card newly placed face down in the banker area 22) is turned face up by the dealer, the computer device 120 proceeds to step S222. In a step before step S221, the computer device 120 may, for example, cause the banker-side notification lamp 130b to illuminate in blue, thereby navigating the dealer so as to have the third card (face down) to the banker side turned face up.

In step S222, the computer device 120 determines whether there are three cards placed face up in the banker area 22. If there are not three cards placed face up in the banker area 22 (NO in step S222), the computer device 120 returns to step S221. Otherwise, or upon determining that there are three cards placed face up in the banker area 22 (YES in step S222), the computer device 120 ends the operation in card dealing based on the third-card rules.

### If it is not Needed to Deal the Third Card to the Player Side (NO in Step S201)

In step S223, the computer device 120 causes the banker-side notification lamp 130b to illuminate in white, thereby navigating the dealer so as to have the third card (face down) placed in the banker area 22. By seeing the banker-side notification lamp 130b, the dealer recognizes that the third card should be placed (face down) in the banker area 22.

In step S224, the computer device 120 determines whether there are two cards placed face up and one card placed face down in the banker area 22. The computer device 120 proceeds to step S230 upon determining that there are two cards placed face up and one card placed face down in the banker area 22 (YES in step S224), whereas the computer device 120 proceeds to Step S225 upon determining that there are not two cards placed face up and one card placed face down in the banker area 22 (NO in Step S224).

In step S225, the computer device 120 determines whether there are two cards placed face up in the player area 21. Upon determining that there are two cards placed face up in the player area 21 (YES in step S225), the computer device 120 returns to step S224. Otherwise, or if there are not two cards placed face up in the player area 21 (NO in step S204), the computer device 120 determines that the status of card dealing is not normal and proceeds to step S226.

In step S226, the computer device 120 causes the player-side notification lamp 130a and the banker-side notification lamp 130b to flash in red, and proceeds to step S227. By seeing the player-side notification lamp 130a and the banker-side notification lamp 130b flashing in red, the dealer recognizes that an error about dealing of cards has occurred.

In step S227, the computer device 120 again determines whether there are two cards placed face up and one card placed face down in the banker area 22. For example, if the dealer, having recognized an error about dealing of cards, has newly placed one card (face down) in the banker area 22, the computer device 120 determines that there are such cards in the area (“YES”), and proceeds to step S228. If there is not one card (face down) newly placed in the banker area 22 (NO in step S227), the computer device 120 determines that the status of card dealing is still not normal and returns to step S226 to continue notification of an error about dealing of cards.

In step S228, the computer device 120 determines whether there are two cards placed face up in the player area 21. If there are not two cards placed face up in the banker area 21 (NO in step S228), the computer device 120 determines that the status of card dealing is still not normal and returns to step S226 to continue providing notification of an error about dealing of cards. Otherwise, or upon determining that there are two cards placed face up in the player area 21 (YES in step S228), the computer device 120 determines that the status of card dealing has returned to normal and proceeds to step S229.

In step S229, the computer device 120 turns off the player-side notification lamp 130a and the banker-side notification lamp 130b, and proceeds to step S230. By seeing the player-side notification lamp 130a and the banker-side notification lamp 130b turned off, the dealer recognizes that the error about dealing of cards has been resolved.

In step S230, upon detecting when the third card to the banker side (i.e., the card newly placed face down in the banker area 22) is turned face up by the dealer, the computer device 120 proceeds to step S231. In a step before step S230, the computer device 120 may, for example, cause the banker-side notification lamp 130b to illuminate in blue, thereby navigating the dealer so as to have the third card (face down) to the banker side turned face up.

In step S231, the computer device 120 determines whether there are three cards placed face up in the banker area 22. If there are not three cards placed face up in the banker area 22 (NO in step S231), the computer device 120 returns to step S230. Otherwise, or upon determining that there are three cards placed face up in the banker area 22 (YES in step S231), the computer device 120 ends the operation in card dealing based on the third-card rules.

After ending the operation in card dealing based on the third-card rules, the computer device 120 determines the win-loss result of the game based on information such as the rule information, and makes notification of the win-loss result of through, for example, the notification device 130, the display units 27, 36, or the like.

As described above, the game table 100 according to the present embodiment detects an error about dealing of cards based on the result of comparison between the card information read by the reading device 110 and the rule information stored in the storage unit 121 and makes notification of the status of occurrence of an error by using the notification device 130. This enables the dealer and the users participating in the game to promptly identify an error about dealing of cards, thus enabling sound and fair operation of an amusement facility.

In addition, the game table 100 generates navigation information for properly proceeding with a card game and notifies the dealer of the information by using the notification device 130, and thus can prevent errors about dealing of cards from occurring.

### B. Others

The above described embodiments are intended to facilitate understanding of the present invention and are not intended to limit interpretation of the present invention. Each element included in the embodiments and the arrangement, material, conditions, shape, size, and the like of the element are not limited to those exemplarily presented but can be changed as appropriate. Additionally, configurations presented in different embodiments can be partially exchanged or combined. For example, while the description exemplarily presents baccarat, a traditional card game in the present embodiment, the present embodiment can be applied to other card games such as blackjack.

Furthermore, the player-side notification lamp 130a and the banker-side notification lamp 130b may be configured to emit light in different patterns for different kinds of error about dealing of cards. For example, the first notification control unit 122 may be configured to: cause the corresponding notification lamp 130 to flash in red if the number of cards dealt is wrong; and cause the corresponding notification lamp 130 to flash in yellow if the face and back of a card face wrongly. Likewise, the player-side notification lamp 130a and the banker-side notification lamp 130b may be configured to emit light in different patterns for different kinds of navigation about dealing of cards. For example, the second notification control unit 123 may cause the corresponding notification lamp 130 to illuminate in white if there is a card that needs to be dealt, and may cause the corresponding notification lamp 130 to illuminate in blue if it is the right time to turn face up a card placed face down. Note that the patterns in which light is emitted include illuminating and flashing, colors of light, brightness levels, or combinations of these patterns.

Note that notification of the status of occurrence of an error and the navigation information is provided through the player-side notification lamp 130a and the banker-side notification lamp 130b in the present embodiment but may be provided through the display unit 27 on the dealer side in addition to or in place of those lamps. Alternatively, notification of the status of occurrence of an error and the navigation information may be made through voice messages, sound effects, or the like from an audio system (a sound notification unit) mounted on the game table 100 and including a speaker, an amplifier, and the like. In this case, different patterns of sound may be used for different kinds of error about dealing of cards and for different kinds of navigation about dealing of cards. Furthermore, sound notification may be output to headphones or another device so that only the dealer can be notified.

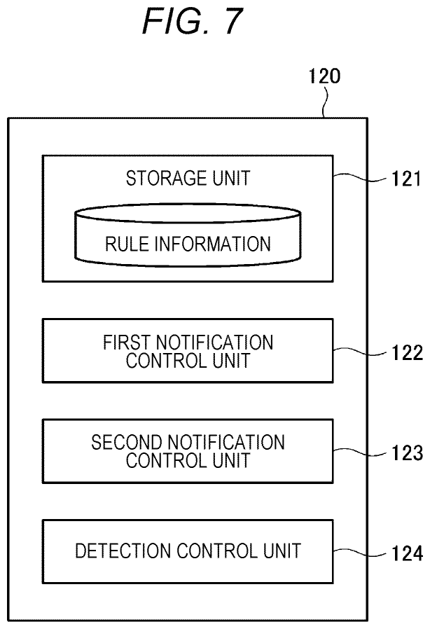

Furthermore, notification of detected errors may be immediately made using the notification device 130, or may be recorded as a log in the storage unit 121 so that it can be output from the storage unit 121 for later viewing, tabulation, or the like. Specifically, as illustrated in FIG. 7, a detection control unit 124 is provided in the computer device 120. The detection control unit 124 detects an error about dealing of cards based on the result of comparison between the card information and the rule information, and records or outputs the detected error. This configuration enables speeding up the proceeding and the like of a card game that are related to casino operation. At least one of the functional modules (i.e., the storage unit 121, the first notification control unit 122, the second notification control unit 123, and the detection control unit 124) included in the computer device 120 of the game table 100 in FIGS. 4 and 7 may be provided in a server (not illustrated) connected via a network. Such a configuration enables centralized and efficient processing on notification control, data storage, and the like in a plurality of game tables 100.

1. A game-table computer device configured to manage proceeding of a card game that uses a game table provided with a reading device configured to read card information on cards dealt into a play area, the computer device comprising:
a storage unit configured to store rule information on the card game; and
a detection control unit configured to detect an error about dealing of the cards based on a result of comparison between the card information and the rule information and record or output the detected error.

2. A game-table computer device configured to manage proceeding of a card game that uses a game table provided with a reading device and a notification device, the reading device being configured to read card information on cards dealt into a play area, the computer device comprising:
a storage unit configured to store rule information on the card game; and
a first notification control unit configured to detect an error about dealing of the cards based on a result of comparison between the card information and the rule information and cause the notification device to provide notification of a status of occurrence of the error.

3. The computer device according to claim 2, wherein the card information includes a face or back, a position, and a type of each of the cards.

4. The computer device according to claim 3, wherein
the notification device includes a light emission unit and/or a sound notification unit provided in the play area, and
the first notification control unit switches the light emission unit between different light emitting patterns and/or the sound notification unit between different sound patterns for different kinds of the error.

5. The computer device according to claim 3, wherein
a plurality of card placement areas are provided for placing the cards, and
the notification device is provided corresponding to each of the card placement areas.

6. A game-table computer device configured to manage proceeding of a card game that uses a game table provided with a reading device and a notification device, the reading device being configured to read card information on cards dealt into a play area, the computer device comprising:
a storage unit configured to store rule information on the card game; and
a second notification control unit configured to generate navigation information for navigating a dealer through the proceeding of the card game based on a result of comparison between the card information and the rule information and cause the notification device to provide notification of the navigation information.

7. The computer device according to claim 6, wherein
the notification device includes a light emission unit and/or a sound notification unit provided in the play area, and
the second notification control unit switches the light emission unit between different light emitting patterns and/or the sound notification unit between different sound patterns for different kinds of the navigating.

8. A system including a computer device and a server, the computer device being configured to manage proceeding of a card game that uses a game table provided with a reading device configured to read card information on cards dealt into a play area, the system comprising in at least either of the computer device and the server:
a storage unit configured to store rule information on the card game; and
a detection control unit configured to detect an error about dealing of the cards based on a result of comparison between the card information and the rule information and record or output the detected error.
